(19) United States
(12) Patent Application Publication
(10) Pub. No.: US 2023/0098910 A1
(43) Pub. Date: Mar. 30, 2023

(54) METHOD FOR TRACKING HEAD MOUNTED DISPLAY DEVICE AND HEAD MOUNTED DISPLAY SYSTEM

(71) Applicant: GUANGDONG OPPO MOBILE TELECOMMUNICATIONS CORP., LTD., Dongguan (CN)

(72) Inventors: Yuxin MA, Palo Alto, CA (US); Yi XU, Palo Alto, CA (US)

(21) Appl. No.: 18/061,171

(22) Filed: Dec. 2, 2022

Related U.S. Application Data
(63) Continuation of application No. PCT/CN2021/090048, filed on Apr. 26, 2021.
(60) Provisional application No. 63/035,242, filed on Jun. 5, 2020.
(60) Provisional application No. 63/036,551, filed on Jun. 9, 2020.

(51) Int. Cl. G06F 3/01; G02B 27/01; G06T 7/73; G06T 7/246

(52) U.S. Cl. CPC G06F 3/012; G02B 27/017; G06T 7/73; G06T 7/246; G02B 2027/014; G06T 2207/10028; G02B 2027/0138

(57) ABSTRACT

A method for tracking a head mounted display (HMD) device is provided. The method includes: tracking a pose of a mobile device in a reference coordinate system by running a pose tracking algorithm on the mobile device; tracking an image of the mobile device in the reference coordinate system by at least one sensor of the HMD device; and obtaining, by the HMD device, localization information of the HMD device based on the pose and the image of the mobile device. A head mounted display system is also provided.

### CROSS REFERENCE TO RELATED APPLICATIONS

The present application is a continuation of International Application No. PCT/CN2021/090048, filed Apr. 26, 2021, which claims priority to U.S. Provisional Application No. 63/035,242, filed Jun. 5, 2020, and priority to U.S. Provisional Application No. 63/036,551, filed Jun. 9, 2020. The entire disclosures of the aforementioned applications are incorporated herein by reference.

### TECHNICAL FIELD

The present disclosure relates to head mounted display tracking technologies, and more particularly, to a method for tracking a head mounted display (HMD) device and a head mounted display system.

### BACKGROUND

Performing 6 degree-of-freedom (6 DoF) tracking by a head mounted display (HMD) has the advantage of minimizing system latency. The system latency refers to delay between actions of the HMD and display changes in response to the actions. Large system latency breaks temporal coherence and leads to judder for the HMD. Processing sensor data directly on the HMD can minimize data transmission and reduce the system latency. However, performing the 6 DoF tracking by the HMD has two disadvantages. First, the HMD needs certain hardware (e.g., chips and memory) to process the sensor data and perform a simultaneous localization and mapping (SLAM). This leads to more hardware components, less industry design possibilities, and higher prices. Second, The SLAM includes intensive computations. This leads to larger power consumption and heat accumulation of the HMD.

On the other hand, performing 6 DoF tracking by a mobile device tethered to an HMD reduces power consumption and heat accumulation of the HMD, requires less powerful hardware on the HMD, and provides more flexibility with industry design. However, the added delay of transmitting sensor data from the HMD to a processing unit of the mobile device destroys visual quality of images displayed by the HMD.

Therefore, there is a need to solve the problems in the existing arts of this field.

### SUMMARY

In a first aspect of the present disclosure, a method for tracking a head mounted display device is provided. The method for tracking a head mounted display device includes: tracking a pose of a mobile device in a reference coordinate system by the mobile device; tracking an image of the mobile device in the reference coordinate system by at least one sensor of the HMD device; and obtaining, by the HMD device, localization information of the HMD device based on the pose and the image of the mobile device.

In a second aspect of the present disclosure, a method for tracking a head mounted display device is provided. The method for tracking a head mounted display device includes: tracking a pose of a mobile device in a reference coordinate system by the mobile device; and tracking a pose of the HMD device in the reference coordinate system by a camera of the mobile device.

In a third aspect of the present disclosure, a head mounted display system is provided. The head mounted display system includes: a mobile device configured to track a pose of the mobile device in a reference coordinate system by the mobile device; and a head mounted display (HMD) device including at least one sensor and configured to track an image of the mobile device in the reference coordinate system via the at least one sensor and obtain localization information of the HMD device in the reference coordinate system based on the pose and the image of the mobile device.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a flowchart of a method for tracking a head mounted display device in accordance with an embodiment of the present disclosure.

FIG. 2 illustrates some markers in accordance with an embodiment of the present disclosure. The markers are pre-defined images with known geometry.

FIG. 3 illustrates a flowchart of a method for tracking a head mounted display device in accordance with another embodiment of the present disclosure.

FIG. 4 illustrates a head mounted display system in accordance with an embodiment of the present disclosure.

FIG. 5 illustrates a head mounted display system in accordance with another embodiment of the present disclosure.

FIG. 6 illustrates a head mounted display system in accordance with yet another embodiment of the present disclosure.

FIG. 7 illustrates a head mounted display system in accordance with yet another embodiment of the present disclosure.

FIG. 8 illustrates a block diagram of a mobile device in accordance with an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

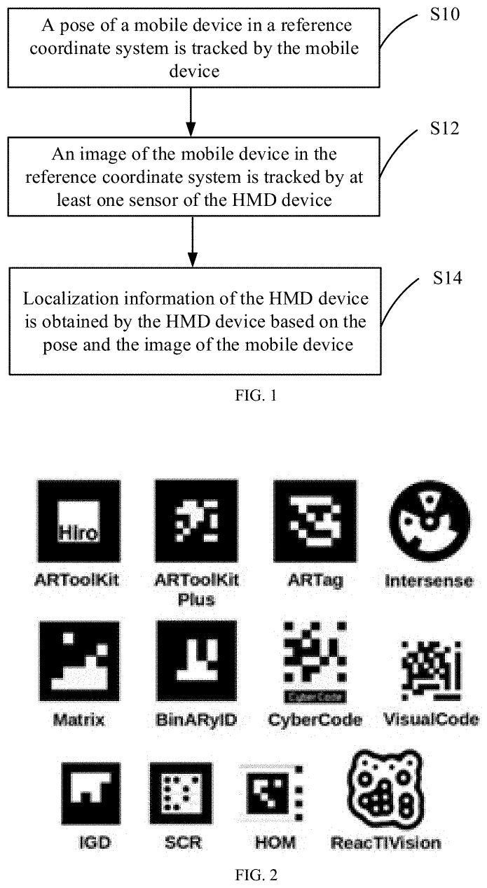

Please refer to FIG. 1. FIG. 1 illustrates a flowchart of a method for tracking a head mounted display (HMD) device in accordance with an embodiment of the present disclosure.

The HMD device is mounted on the head of a user. The HMD device is configured to display an image on a display unit disposed in front of the eyes of the user. The HMD device is a device which is worn on the head of the user to provide an immersive visual experience for the user. The head mounted display can enable the user to have an immersive feeling into a virtual space.

In step S10, a pose of a mobile device in a reference coordinate system is tracked by the mobile device.

In step S10, the pose of the mobile device is tracked (i.e., obtained) by itself. In detail, the pose of the mobile device in the reference coordinate system is tracked by a pose tracking module in the mobile device. The reference coordinate system is established by the pose tracking module. The reference coordinate system is a coordinate system of an environment where the mobile device is located. The pose tracking module can be a sensor module for tracking the pose of the mobile device or a pose tracking algorithm for tracking the pose of the mobile device. The pose tracking algorithm is an algorithm used for tracking a 6 degree-of-freedom (6 DoF) pose of the mobile device. The 6 DoF pose of the mobile device includes 3 DoF positions and 3 DoF orientations of the mobile device. That is, the mobile device runs the pose tracking algorithm to track (obtain) the 3 DoF positions and the 3 DoF orientations of the mobile device in the reference coordinate system.

The pose tracking algorithm can be, for example, a visual odometry (VO) algorithm, a visual inertial odometry (VIO) algorithm, a simultaneous localization and mapping (SLAM) algorithm or the like.

The VO algorithm can estimate a six-dimensional position (x, y, z, roll, pitch, and yaw) of an object from its initial starting position using an iterative closest point (ICP) and random sample consensus (RANSAC)-based algorithm. A current algorithm can extract key features from a frame and compare the key features to a reference frame. Furthermore, the VO algorithm can produce odometry comparable to tracked odometry. The VO algorithm can also provide complete six-dimensional odometry: x, y, z, roll, pitch, and yaw. In the VO algorithm, the 3 DoF positions and the 3 DoF orientations of the mobile device are determined by analyzing sequential images captured by a camera of the mobile device. That is, the VO algorithm is used for determining equivalent odometry information using the sequential images to estimate a traveled distance of the mobile device in real time.

VIO is the process of estimating the state (pose and velocity) of an agent (e.g., an aerial robot) by using only the input of one or more cameras plus one or more Inertial Measurement Units (IMUs) attached to it. VIO is the only viable alternative to global positioning system (GPS) and lidar-based odometry to achieve accurate state estimation. Since both cameras and IMUs are very cheap, these sensor types are ubiquitous in all applications. In the VIO algorithm, an inertial measurement unit (IMU) is used in a VO system. The VIO algorithm uses the VO algorithm to estimate the pose of the mobile device from the sequential images in combination with inertial measurements from the IMU. The IMU is used for correcting errors associated with rapid movement of the mobile device resulting in poor image capture.

SLAM is a computational problem of constructing or updating a map of an unknown environment while simultaneously keeping track of a location of an object within it. In the SLAM algorithm, a map of an environment where the mobile device is located is constructed or updated while the location of the mobile device within the map is tracked simultaneously.

In step S12, an image of the mobile device in the reference coordinate system is tracked by at least one sensor of the HMD device. In case that at least one marker is displayed on the mobile device, the image of the mobile device may be an image of a part of the mobile device (such as an image illustrating only the at least one marker displayed on the mobile device), or an image of the entire of the mobile device (an image illustrating both the at least one marker and other portions of the mobile device).

The at least one sensor is attached to the HMD device.

In step S14, localization information of the HMD device in the reference coordinate system is obtained by the HMD device based on the pose and the image of the mobile device.

In one embodiment, the at least one sensor is an image sensor, and the mobile device includes a display. The image of the mobile device is tracked by the image sensor of the HMD device. Step S12 includes tracking the image of the mobile device in the reference coordinate system by capturing, by the image sensor, an image of at least one marker displayed by the display of the mobile device. Step S14 includes computing and obtaining, by the HMD device, the localization information of the HMD device in the reference coordinate system by processing the image of the at least one marker captured by the HMD device and using the pose of the mobile device.

In detail, a set of 2D feature points Pi (i=0, 1, 2, 3, . . . ) are detected from the image of the at least one marker. A location and an orientation of the at least one marker with respect to the reference coordinate system can be computed using the pose of the mobile device and geometry information of the mobile device. The geometry information of the mobile device can be obtained from the manufacturer of the mobile device or from an offline calibration process. Therefore, a 3D location for each 2D feature point P_i can be obtained in the reference coordinate system. To this end, corresponding 3D coordinates of the 2D feature points P_i on the captured image of the at least one marker are established. Based on the 3D coordinates, the pose of the HMD device in the reference coordinate system which is established by the pose tracking module of the mobile device can be computed and obtained. In one embodiment of the present disclosure, the pose of the HMD device can be obtained using a Perspective-n-Point algorithm continuously in real time (e.g., Open Source library OpenCV has a function called solvePnP).

FIG. 2 illustrates some markers in accordance with an embodiment of the present disclosure. The markers are pre-defined images with known geometry. As shown, each of the markers is a black/white image of a geometry primitive with a known size. Alternatively, each of the markers is a natural color image with a certain number of distinctive features. The at least one marker displayed by the display of the mobile device is provided for the HMD device to track the mobile device.

In another embodiment, the at least one sensor is a depth sensor. The depth sensor is configured to capture a depth image of the mobile device and sense depth data of the mobile device from the depth image, and the HMD device is configured to track the image of the mobile device by using the depth data of the mobile device. Step S12 includes tracking the image of the mobile device in the reference coordinate system by capturing, by the depth sensor, the depth image of the mobile device and sensing, by the depth sensor, the depth data of the mobile device. Step S14 includes obtaining, by the HMD device, the localization information of the HMD device based on the depth data and the pose of the mobile device tracked by the mobile device.

In detail, the depth sensor, for example, is a Time-of-Flight (ToF) camera (sensor). The depth sensor is configured to sense depth data of the mobile device by capturing the depth image of the mobile device to detect and track the mobile device. Although there are many detectable surfaces in the environment, the main body of the mobile device can be identified by information, such as a size, distance constraints or the like. Alternatively, the main body of the mobile device can be identified by a user during an initialization process of the HMD device. For example, the user holds the mobile device in front of the depth sensor on the HMD device. Template images for the mobile device can be captured. Selection and matching of the template images can be used to estimate the pose of the mobile device. Moreover, red-green-blue (RGB) images from an RGB camera and depth images from the depth sensor can be used together to improve accuracy of tracking the mobile device. For example, the main body of the mobile device can be obtained by combining silhouette gradient orientations from RGB images and surface normal orientations from depth images. Furthermore, data from an inertial measurement unit (IMU) can also be used to reduce computational complexity. The IMU can estimate the gravity directions of the mobile device and the HMD device. As such, the number of free parameters can be reduced when the captured images of the mobile device are matched and aligned with the template images of the mobile device. Once the HMD device can track the pose of the main body of mobile device, the pose (including the position and the orientation) of the HMD device in the reference coordinate system can be computed by applying a transformation from the mobile device to the HMD device to the pose of the mobile device. Therefore, the HMD device can be localized in the reference coordinate system by combining the real time pose of the mobile device and relative transformation from the mobile device to the HMD device.

In summary, the embodiment in FIG. 1 provides two methods for tracking the image of the mobile device in the reference coordinate system. One method is to use the image sensor in combination with the display of the mobile device, and the other method is to use the depth sensor.

In the method for tracking the HMD device of the embodiment in FIG. 1, the pose of the mobile device is tracked by the mobile device by itself. As such, the HMD device can avoid heavy computations of tracking the 6 DoF pose of the HMD device (i.e. itself) using a pose tracking algorithm, and the weight, hardware complexity, and power consumption of the HMD device can be reduced. Accordingly, power consumption of the HMD device can be improved, and excessive structures or elements required for heat dissipation can be reduced. Furthermore, since the mobile device and the HMD device are tracked within the same reference coordinate system, the mobile device can be used as a 6 DoF controller.

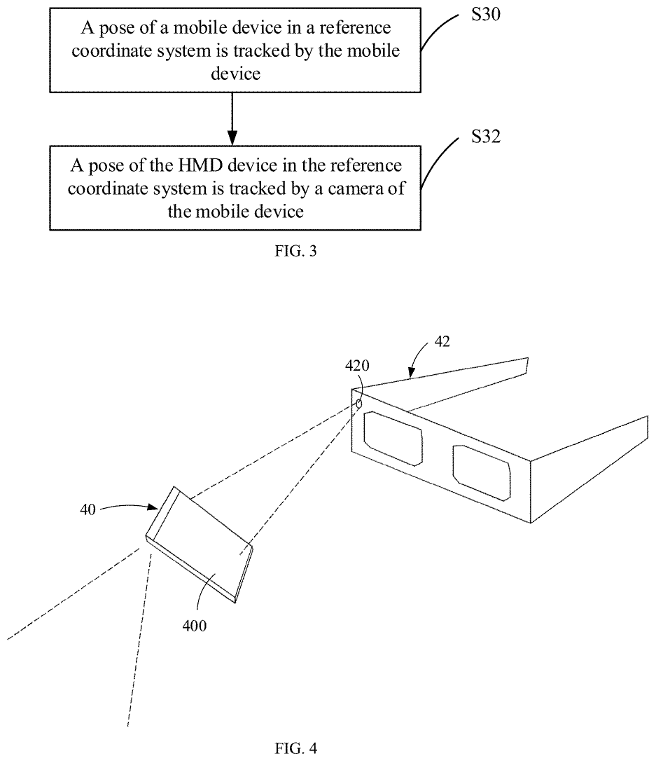

Please refer to FIG. 3. FIG. 3 illustrates a flowchart of a method for tracking a head mounted display (HMD) device in accordance with another embodiment of the present disclosure.

In step S30, a pose of a mobile device in a reference coordinate system is tracked by the mobile device.

In step S30, the pose of the mobile device is tracked (i.e., obtained) by itself. In detail, the pose of the mobile device in the reference coordinate system is tracked by a pose tracking module in the mobile device. The reference coordinate system is established by the pose tracking module. The reference coordinate system is a coordinate system of an environment where the mobile device is located. The pose tracking module can be a sensor module for tracking the pose of the mobile device or a pose tracking algorithm for tracking the pose of the mobile device. The pose tracking algorithm is an algorithm used for tracking a 6 degree-of-freedom (6 DoF) pose of the mobile device. The 6 DoF pose of the mobile device includes 3 DoF positions and 3 DoF orientations of the mobile device. That is, the mobile device runs the pose tracking algorithm to track (obtain) the 3 DoF positions and the 3 DoF orientations of the mobile device in the reference coordinate system.

The pose tracking algorithm can be, for example, a visual odometry (VO) algorithm, a visual inertial odometry (VIO) algorithm, a simultaneous localization and mapping (SLAM) algorithm or the like.

In step S32, a pose of the HMD device in the reference coordinate system is tracked by a camera of the mobile device.

The HMD device includes a plurality of markers. The markers are attached to the HMD device. Step S32 includes tracking the pose of the HMD device in the reference coordinate system by observing the markers via the camera.

In one embodiment, the markers are reflective markers, and the camera is an infrared (IR) emitting camera. When the IR emitting camera emits light, the reflective markers reflect the light. Then, the IR emitting camera captures a two-dimensional (2D) image of the reflective markers based on the light reflected by the reflective markers. The 2D image is processed by an image processing algorithm on the mobile device to identify locations of the reflective markers to track the HMD device. The mobile device detects and tracks the HMD device according to the locations of the reflective markers.

In another embodiment, the markers are infrared light emitting diodes (IR LEDs), and the camera is an IR camera. When the IR camera senses IR light emitted by the IR LEDs, the IR camera captures a two-dimensional (2D) image of the IR LEDs based on the IR light. The 2D image is processed by an image processing algorithm on the mobile device to identify locations of the IR LEDs to track the HMD device. The mobile device detects and tracks the HMD device according to the locations of the IR LEDs.

In yet another embodiment, the mobile device is further configured to track the HMD device by a three-dimensional (3D) object pose estimation method.

In summary, the embodiment in FIG. 3 provides three methods for tracking the pose of the HMD device in the reference coordinate system. One method is to use the reflective markers in combination with the IR emitting camera, another method is to use the IR LEDs in combination with IR camera, and the other method is to use a 3D object pose estimation method.

In the method for tracking the HMD device of the embodiment in FIG. 3, the pose of mobile device is tracked by the mobile device by itself. As such, the HMD device can avoid heavy computations of tracking the 6 DoF pose of the HMD device (i.e. itself) using a pose tracking algorithm, and the weight, hardware complexity, and power consumption of the HMD device can be reduced. Accordingly, power consumption of the HMD device can be improved, and excessive structures or elements required for heat dissipation can be reduced. Furthermore, since the mobile device and the HMD device are tracked within the same reference coordinate system, the mobile device can be used as a 6 DoF controller. Furthermore, the HMD device is tracked by the mobile device. As such, the power consumption of the HMD device can be further reduced.

Please refer to FIG. 4. FIG. 4 illustrates a head mounted display system in accordance with an embodiment of the present disclosure.

The head mounted display system includes a mobile device 40 and a head mounted display (HMD) device 42. The mobile device 40 can communicate with the HMD device 42 via a universal serial bus (USB) cable. Alternatively, the mobile device 40 can communicate with the HMD device 42 via wireless fidelity (Wi-Fi), BLUETOOTH or the like.

The mobile device 40, for example, is a smartphone, but the present disclosure is not limited thereto. The mobile device 40 is configured to track (i.e., obtain) a pose of the mobile device 40 in a reference coordinate system by itself. In detail, the mobile device 40 is configured to track the pose of the mobile device 40 (i.e., itself) in the reference coordinate system by a pose tracking module in the mobile device 40. The reference coordinate system is established by the pose tracking module. The reference coordinate system is a coordinate system of an environment where the mobile device 40 is located. The pose tracking module can be a sensor module for tracking the pose of the mobile device 40 or a pose tracking algorithm for tracking the pose of the mobile device 40. The pose tracking algorithm is an algorithm used for tracking a 6 degree-of-freedom (6 DoF) pose of the mobile device 40. The pose tracking algorithm can be, for example, a visual odometry (VO) algorithm, a visual-inertial odometry (VIO) algorithm, a simultaneous localization and mapping (SLAM) algorithm or the like. The 6 DoF pose of the mobile device 40 includes 3 DoF positions and 3 DoF orientations of the mobile device 40. That is, the mobile device 40 runs the pose tracking algorithm to track the 3 DoF positions and the 3 DoF orientations of the mobile device 40 in the reference coordinate system.

The HMD device 42 is, for example, augmented reality (AR) glasses, mixed reality (MR) glasses, virtual reality (VR) glasses or the like. The HMD device 42 includes at least one sensor 420 attached thereto. The HMD device 42 is configured to track the mobile device 40 via the at least one sensor 420 (for example, by tracking an image of the mobile device 40 via the at least one sensor 420) and obtain localization information of the HMD device 42 in the reference coordinate system based on the tracked image and the pose of the mobile device tracked by the mobile device itself.

In one embodiment, the mobile device 40 includes a display 400, and the at least one sensor 420 is an image sensor. The display 400 is configured to display at least one marker. FIG. 2 illustrates some markers in accordance with an embodiment of the present disclosure. The markers are pre-defined images with known geometry. Each of the markers is a black/white image of a geometry primitive with a known size. Alternatively, each of the markers is a natural color image with a certain number of distinctive features. The at least one marker displayed by the display 400 of the mobile device 40 is provided for the HMD device 42 to track the mobile device 40.

The image sensor, for example, is a red-green-blue (RGB) camera or a monochrome camera, but the present disclosure is not limited thereto. The image sensor is configured to track the image of the mobile device by capturing an image of the at least one marker displayed by the display 400 of the mobile device 40. The HMD device 42 is configured to process the image of the at least one marker captured by the HMD device 42 and use the pose of the mobile device to obtain the localization information (i.e., a position and an orientation) of the HMD device 42 in the reference coordinate system which is established by the pose tracking module.

In detail, a set of 2D feature points Pi (i=0, 1, 2, 3, . . . ) are detected from the image of the at least one marker. A location and an orientation of the at least one marker with respect to the reference coordinate system can be computed using the pose of the mobile device 40 and geometry information of the mobile device 40. The geometry information of the mobile device 40 can be obtained from the manufacturer of the mobile device 40 or from an offline calibration process. Therefore, the 3D location for each 2D feature point Pi can be obtained in the reference coordinate system. To this end, corresponding 3D coordinates of the 2D feature points P_i on the captured image of the at least one marker are established. Based on the 3D coordinates, the pose of the HMD device 42 in the reference coordinate system which is established by the pose tracking module of the mobile device 40 can be computed and obtained. In one embodiment of the present disclosure, the pose of the HMD device 42 can be obtained using a Perspective-n-Point algorithm continuously in real time (e.g., Open Source library OpenCV has a function called solvePnP).

In another embodiment, the at least one sensor 420 is a depth sensor. The depth sensor, for example, is a Time-of-Flight (ToF) camera (sensor). The depth sensor is configured to track the image of the mobile device by capturing a depth image of the mobile device and sense depth data of the mobile device 40 from the depth image to detect and track the mobile device 40. The HMD device 42 is configured to track the mobile device using the depth data and the pose of the mobile device. Although there are many detectable surfaces in the environment, the main body of the mobile device 40 can be identified by information, such as a size, distance constraints or the like. Alternatively, the main body of the mobile device 40 can be identified by a user during an initialization process of the HMD device 42. For example, the user holds the mobile device 40 in front of the depth sensor on the HMD device 42. Template images for the mobile device 40 can be captured. Selection and matching of the template images can be used to estimate the pose of the mobile device 40. Moreover, red-green-blue (RGB) images from an RGB camera and depth images from the depth sensor can be used together to improve accuracy of tracking the mobile device 40. For example, the main body of the mobile device 40 can be obtained by combining silhouette gradient orientations from RGB images and surface normal orientations from depth images. Furthermore, data from an inertial measurement unit (IMU) can also be used to reduce computational complexity. The IMU can estimate the gravity directions of the mobile device 40 and the HMD device 42. As such, the number of free parameters can be reduced when the captured images of the mobile device 40 are matched and aligned with the template images of the mobile device 40. Once the HMD device 42 can track the pose of the main body of mobile device 40, the pose (including the position and the orientation) of the HMD device 42 in the reference coordinate system can be computed by applying a transformation from the mobile device 40 to the HMD device 42 to the pose of the mobile device 40.

In the head mounted display system of the embodiment in FIG. 4, the pose of the mobile device 40 is tracked by the mobile device 40 by itself. As such, the HMD device 42 can avoid heavy computations of tracking the 6 DoF pose of the HMD device 42 (i.e., itself) using a pose tracking algorithm, and the weight, hardware complexity, and power consumption of the HMD device 42 can be reduced. Accordingly, power consumption of the HMD device 42 can be improved, and excessive structures or elements required for heat dissipation can be reduced. Furthermore, since the mobile device 40 and the HMD device 42 are tracked within the same reference coordinate system, the mobile device 40 can be used as a 6 DoF controller.

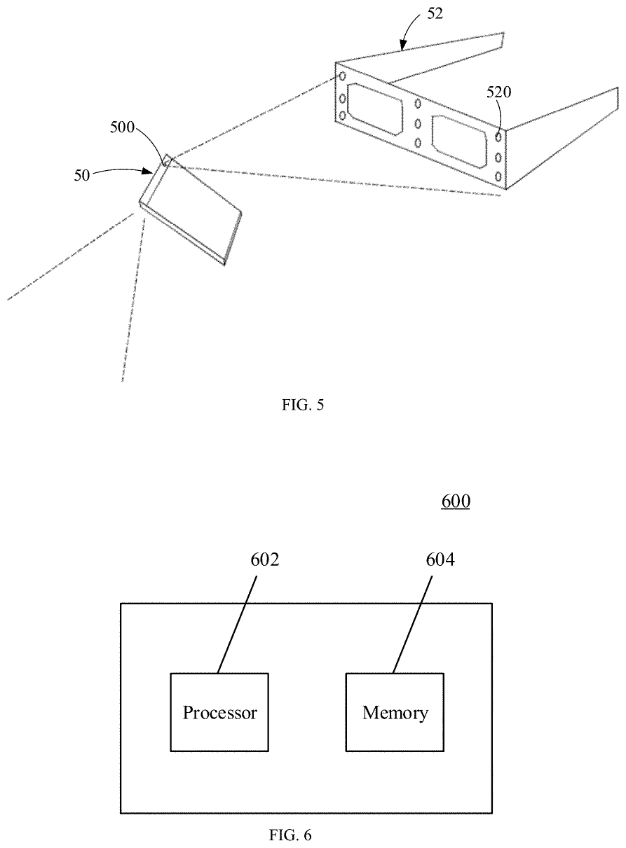

Please refer to FIG. 5. FIG. 5 illustrates a head mounted display system in accordance with another embodiment of the present disclosure.

The head mounted display system includes a mobile device 50 and a head mounted display (HMD) device 52.

The mobile device 50, for example, is a smartphone, but the present disclosure is not limited thereto. The mobile device 50 is configured to track (i.e., obtain) a pose of the mobile device 50 in a reference coordinate system. In detail, the mobile device 50 is configured to track the pose of the mobile device 50 (i.e., itself) in the reference coordinate system by a pose tracking module in the mobile device 50. The reference coordinate system is established by the pose tracking module. The reference coordinate system is a coordinate system of an environment where the mobile device 50 is located. The pose tracking module can be a sensor module for tracking the pose of the mobile device 50 or a pose tracking algorithm for tracking the pose of the mobile device 50. The pose tracking algorithm is an algorithm used for tracking a 6 DoF pose of the mobile device 50. The pose tracking algorithm can be, for example, a visual odometry (VO) algorithm, a visual-inertial odometry (VIO) algorithm, an SLAM algorithm or the like. The 6 DoF pose of the mobile device 50 includes 3 DoF positions and 3 DoF orientations of the mobile device 50. That is, the mobile device 50 runs the pose tracking algorithm to track the 3 DoF positions and the 3 DoF orientations of the mobile device 50 in the reference coordinate system.

The mobile device 50 includes a camera 500. The camera 500 can be a front-facing camera or a back-facing camera. The mobile device 50 is further configured to track the HMD device 52 via the camera 500.

The HMD device 52 includes a plurality of markers 520 attached thereto. The mobile device 50 is configured to track a position and an orientation of the HMD device 52 by observing the markers 520 via the camera 500. The markers 520 can be arranged in the form of a matrix or a constellation, but the present disclosure is not limited thereto. The markers 520 are located at 3D locations L_i(i=0, 1, 2, 3, . . . ) on the HMD device 52. The markers 520 can be disposed behind transparent plastic material of the HMD device 52 for better product design possibilities.

In one embodiment, the markers 520 are reflective markers, and the camera 500 is an infrared (IR) emitting camera. When the IR emitting camera emits light, the reflective markers reflect the light. Then, the IR emitting camera captures a 2D image of the reflective markers based on the reflected light. The 2D image is processed by an image processing algorithm on the mobile device 50 to identify locations of the reflective markers. The mobile device 50 detects and tracks the HMD device 52 according to the locations of the reflective markers.

For example, the 2D image can be processed using at least one of a color thresholding technique and an intensity thresholding technique to output a binary image. Then, the binary image is analyzed to identify the reflective markers as blobs on the 2D image. Centroids of the blobs can be computed as a series of 2D feature points Pi (i=0, 1, 2, 3, . . . ). Correspondences between the 2D feature points P_i on the 2D image of the centroids of the blobs and corresponding 3D coordinates can be established by a matching algorithm. Based on the correspondences, the pose of the HMD device 52 with respect to the reference coordinate system which is established by the pose tracking module of the mobile device 50 can be computed and obtained using the pose of the mobile device 50 and the correspondence information. In one embodiment of the present disclosure, the pose of the HMD device 52 can be obtained using a Perspective-n-Point algorithm continuously in real time (e.g., Open Source library OpenCV has a function called solvePnP).

In another embodiment, the markers 520 are infrared light emitting diodes (IR LEDs), and the camera 500 is an IR camera. The IR camera senses IR light emitted by the IR LEDs. The IR camera captures a 2D image of the IR LEDs based on the IR light. The 2D image is processed by an image processing algorithm on the mobile device 50 to identify locations of the IR LEDs. The mobile device 50 detects and tracks the HMD device 52 according to the locations of the IR LEDs.

It is noted that the camera used for tracking the mobile device 50 and the camera used for tracking the HMD device 52 can be the same or different. When the camera used for tracking the mobile device 50 is the same as the camera used for tracking the HMD device 52, the pose of the HMD device 52 in the reference coordinate system which is established by the pose tracking module on the mobile device 50 can be computed by applying a transformation from the mobile device 50 to the HMD device 52 to the pose of the mobile device 50 in the reference coordinate system. When the camera used for tracking the mobile device 50 is different from the camera used for tracking the HMD device 52, the transformation between the two cameras is applied to the pose of the mobile device 50 and then the transformation from the mobile device 50 to the HMD device 52 is applied to the transformed pose.

In yet another embodiment, the mobile device 50 is configured to track the HMD device 52 by a 3D object pose estimation method. In detail, the camera 500 of the mobile device 50 captures an image of the HMD device 52. The image can be a single RGB image, a depth image, or a pair of RGB and depth images. The mobile device 50 is configured to track the HMD device 52 by processing the image using the 3D object pose estimation method. For example, a set of 2D feature points on the HMD device 52 are identified, and a computer vision algorithm is trained to recognize these feature points. Since the correspondences between the 2D feature points and corresponding 3D coordinates can be established by a matching algorithm, the pose of the HMD device 52 in the reference coordinate system can be computed and obtained using the pose of the mobile device 50 and the correspondence information. In one embodiment of the present disclosure, the pose of the HMD device 52 can be obtained using a Perspective-n-Point algorithm continuously in real time (e.g., Open Source library OpenCV has a function called solvePnP).

The estimated pose of the HMD device 52 can be used for rendering virtual content onto a display of the HMD device 52. To decrease display latency perceived by a user, additional display image transformation can be performed based on IMU sensor data from an IMU on the HMD device 52. In detail, when the mobile device 50 sends a display frame to the HMD device 52, the display frame is also associated with the pose for which the virtual content is rendered. The HMD device 52 keeps a short buffer of historical IMU data. Once the display frame is received fully by the HMD device 52, a change from the pose of the HMD device 52 for which the display frame is rendered to the pose of the HMD device 52 when the virtual content is displayed can be computed. Display buffer can be transformed accordingly to compensate for the display latency.

In the head mounted display system of the embodiment in FIG. 5, tracking the pose of the mobile device 50 is executed by the mobile device 50. As such, the HMD device 52 can avoid heavy computations of tracking the 6 DoF pose of the HMD device 52 (i.e. itself) using a pose tracking algorithm, and the weight, hardware complexity, and power consumption of the HMD device 52 can be reduced. Accordingly, power consumption of the HMD device 52 can be improved, and excessive structures or elements required for heat dissipation can be reduced. Furthermore, since the mobile device 50 and the HMD device 52 are tracked within the same reference coordinate system, the mobile device 50 can be used as a 6 DoF controller. Furthermore, the HMD device is tracked by the mobile device 50. As such, the power consumption of the HMD device 52 can be further reduced.

In the method for tracking the head mounted display devices and the head mounted display systems provided by the embodiments of the present disclosure, the pose of the mobile device is tracked by the mobile device itself. As such, the HMD device can avoid heavy computations of tracking the pose of the HMD device (i.e., itself) using a pose tracking algorithm, and the weight, hardware complexity, and power consumption of the HMD device can be reduced.

Please refer to FIG. 6. FIG. 6 illustrates a head mounted display system in accordance with yet another embodiment of the present disclosure.

The head mounted display system 600 includes at least one processor 602 and at least one memory 604. The at least one memory 604 is configured to store program instructions. The at least one processor 602 is configured to execute the program instructions to perform steps of: tracking a pose of a mobile device in a reference coordinate system by the mobile device; tracking the pose of the mobile device in the reference coordinate system by at least one sensor of an HMD device; and obtaining localization information of the HMD device based on the pose of the mobile device.

In one embodiment, the pose tracking algorithm is one of a visual odometry (VO) algorithm, a visual inertial odometry (VIO) algorithm, and a simultaneous localization and mapping (SLAM) algorithm.

In one embodiment, the pose of the mobile device is a 6 degree-of-freedom (6 DoF) pose.

In one embodiment, the mobile device includes a display, and the at least one sensor is an image sensor. The step of tracking the pose of the mobile device in the reference coordinate system by the at least one sensor of the HMD device includes: tracking the pose of the mobile device in the reference coordinate system by capturing, by the image sensor, an image of at least one marker displayed by the display of the mobile device. The step of obtaining the localization information of the HMD device based on the pose of the mobile device includes: computing and obtaining the localization information of the HMD device by processing the image of the at least one marker captured by the HMD device.

In one embodiment, the at least one marker is a black/white image of a geometry primitive with a known size, or a natural color image with a certain number of distinctive features.

In one embodiment, the at least one sensor is a depth sensor. The step of tracking the pose of the mobile device in the reference coordinate system by the at least one sensor of the HMD device includes: tracking the pose of the mobile device in the reference coordinate system by sensing, by the depth sensor, depth data of the mobile device. The step of obtaining the localization information of the HMD device based on the pose of the mobile device includes: obtaining the localization information of the HMD device based on the depth data.

In one embodiment, the HMD device is one of augmented reality (AR) glasses, mixed reality (MR) glasses, and virtual reality (VR) glasses.

Detailed description can be referred to the above-mentioned embodiments and is not repeated herein.

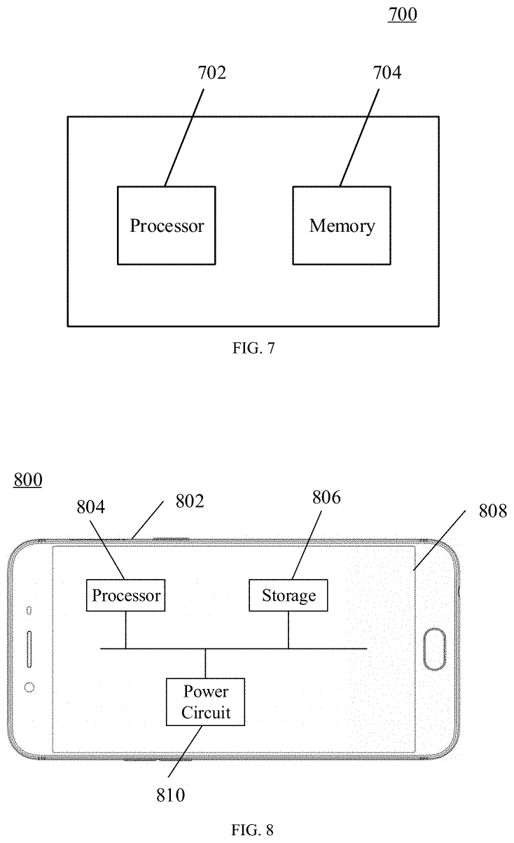

Please refer to FIG. 7. FIG. 7 illustrates a head mounted display system in accordance with yet another embodiment of the present disclosure.

The head mounted display system 700 includes at least one processor 702 and at least one memory 704. The at least one memory 704 is configured to store program instructions. The at least one processor 702 is configured to execute the program instructions to perform steps of: tracking a pose of a mobile device in a reference coordinate system by the mobile device; and tracking a pose of an HMD device in the reference coordinate system by a camera of the mobile device.

In one embodiment, the reference coordinate system is established by the pose tracking module.

In one embodiment, the pose tracking algorithm is one of a visual odometry (VO) algorithm, a visual-inertial odometry (VIO) algorithm, and a simultaneous localization and mapping (SLAM) algorithm.

In one embodiment, the pose of the mobile device is a 6 degree-of-freedom (6 DoF) pose. The step of tracking the pose of the HMD device in the reference coordinate system by the camera of the mobile device includes: tracking the pose of the HMD device in the reference coordinate system by observing the markers via the camera.

In one embodiment, the HMD device includes a plurality of markers.

In one embodiment, the markers are reflective markers, and the camera is an infrared (IR) emitting camera. The step of tracking the pose of the HMD device in the reference coordinate system by the camera of the mobile device includes: emitting light by the IR emitting camera; capturing, by the IR emitting camera, a two-dimensional (2D) image of the reflective markers based on light reflected by the reflective markers; processing the 2D image by an image processing algorithm on the mobile device to identify locations of the reflective markers; and tracking the HMD device according to the locations of the reflective markers.

In one embodiment, the markers are infrared light emitting diodes (IR LEDs), and the camera is an infrared (IR) camera. The step of tracking the pose of the HMD device in the reference coordinate system by the camera of the mobile device includes: sensing, by the IR camera, IR light emitted by the IR LEDs; capturing, by the IR camera, a two-dimensional (2D) image of the IR LEDs based on the IR light; processing the 2D image by an image processing algorithm on the mobile device to identify locations of the IR LEDs; and tracking the HMD device according to the locations of the IR LEDs.

In one embodiment, the step of tracking the pose of the HMD device in the reference coordinate system by the camera of the mobile device includes: tracking the pose of the HMD device in the reference coordinate system by the camera of the mobile device by a three-dimensional (3D) object pose estimation method.

Detailed description can be referred to the above-mentioned embodiments and is not repeated herein.

Please refer to FIG. 8. FIG. 8 illustrates a block diagram of a mobile device 800 in accordance with an embodiment of the present disclosure.

Referring to FIG. 8, the mobile device 800 may include one or a plurality of the following components: a housing 802, a processor 804, a storage 806, a circuit board 808, and a power circuit 810. The circuit board 808 is disposed inside a space defined by the housing 802. The processor 804 and the storage 806 are disposed on the circuit board 808. The power circuit 810 is configured to supply power to each circuit or device of the mobile device 800. The storage 806 is configured to store executable program codes and the pose tracking algorithm. By reading the executable program codes stored in the storage 806, the processor 804 runs a program corresponding to the executable program codes to execute the method for tracking the head mounted display device of any one of the afore-mentioned embodiments.

The processor 804 typically controls overall operations of the mobile device 800, such as the operations associated with display, telephone calls, data communications, camera operations, and recording operations. The processor 804 may include one or more processor 804 to execute instructions to perform actions at all or part of the steps in the above described methods. Moreover, the processor 804 may include one or more modules which facilitate the interaction between the processor 804 and other components. For instance, the processor 804 may include a multimedia module to facilitate the interaction between the multimedia component and the processor 804.

The storage 806 is configured to store various types of data to support the operation of the mobile device 800. Examples of such data include instructions for any application or method operated on the mobile device 800, contact data, Phonebook data, messages, pictures, video, etc. The storage 806 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power circuit 810 supplies power to various components of the mobile device 800. The power circuit 810 may include a power management system, one or more power sources, and any other component associated with generation, management, and distribution of power for the mobile device 800.

In exemplary embodiments, the mobile device 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the storage 806, executable by the processor 804 of the mobile device 800 for performing the above-described methods. For example, the non-transitory computer-readable storage medium may be a ROM, a random access memory (RAM), a CD-ROM, a magnetic tape, a floppy disc, an optical data storage device, and the like. A person having ordinary skill in the art understands that each of the units, modules, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and module in the above-mentioned embodiment since the working processes of the above-mentioned system, device, and module are basically the same. For easy description and simplicity, these working processes will not be detailed.

It is understood that the disclosed system in the embodiments of the present disclosure can be realized with other ways. The above-mentioned embodiments are exemplary only. The division of the modules is merely based on logical functions while other divisions exist in realization. It is possible that a plurality of modules or components are combined or integrated in another system. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules for display are or are not physical modules, that is, located in one place or distributed on a plurality of network modules. Some or all of the modules are used according to the purposes of the embodiments.

Moreover, each of the functional modules in each of the embodiments can be integrated in one processing module, physically independent, or integrated in one processing module with two or more than two modules.

If the software function module is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

A method for tracking a head mounted display (HMD) device is provided, and includes: tracking a pose of a mobile device in a reference coordinate system by the mobile device; tracking an image of the mobile device in the reference coordinate system by at least one sensor of the HMD device; and obtaining, by the HMD device, localization information of the HMD device based on the pose and the image of the mobile device.

In some embodiments, the mobile device includes a display, and the at least one sensor is an image sensor; the step of tracking the pose of the mobile device in the reference coordinate system by the at least one sensor of the HMD device comprises: tracking the image of the mobile device in the reference coordinate system by capturing, by the image sensor, an image of at least one marker displayed by the display of the mobile device; and the operation of obtaining, by the HMD device, the localization information of the HMD device based on the pose and the image of the mobile device includes: obtaining, by the HMD device, the localization information of the HMD device by processing the image of the at least one marker captured by the HMD device and using the pose of the mobile device.

In some embodiments, the at least one marker is a black/white image of a geometry primitive with a known size, or a natural color image with a certain number of distinctive features.

In some embodiments, the at least one sensor is a depth sensor; the operation of tracking an image of the mobile device in the reference coordinate system by at least one sensor of the HMD device includes: tracking the image of the mobile device in the reference coordinate system by capturing, by the depth sensor, a depth image of the mobile device and sensing, by the depth sensor, depth data of the mobile device from the depth image; and the operation of obtaining, by the HMD device, the localization information of the HMD device based on the pose and the image of the mobile device includes: obtaining, by the HMD device, the localization information of the HMD device based on the depth data and the pose.

In some embodiments, the operation of tracking an image of a mobile device in a reference coordinate system by the mobile device includes: tracking the pose of the mobile device in the reference coordinate system by a pose tracking module in the mobile device, the reference coordinate system is established by the pose tracking module.

In some embodiments, the HMD device is one of augmented reality (AR) glasses, mixed reality (MR) glasses, and virtual reality (VR) glasses, and the pose of the mobile device is a 6 degree-of-freedom (6 DoF) pose, and the 6 DoF pose comprises 3 DoF positions and 3 DoF orientations of the mobile device.

In some embodiments, the mobile device and the HMD device are tracked within the same reference coordinate system, wherein the reference coordinate system is established by a pose tracking module in the mobile device.

A method for tracking a head mounted display (HMD) device is provided, and includes: tracking a pose of a mobile device in a reference coordinate system by the mobile device; and tracking a pose of the HMD device in the reference coordinate system by a camera of the mobile device.

In some embodiments, the HMD device includes a plurality of markers; and the step of tracking the pose of the HMD device in the reference coordinate system by the camera of the mobile device includes: tracking the pose of the HMD device in the reference coordinate system by observing the markers via the camera.

In some embodiments, the markers are reflective markers, and the camera is an infrared (IR) emitting camera; and the step of tracking the pose of the HMD device in the reference coordinate system by the camera of the mobile device includes: emitting light by the IR emitting camera; capturing, by the IR emitting camera, a two-dimensional (2D) image of the reflective markers based on light reflected by the reflective markers; processing the 2D image by an image processing algorithm on the mobile device to identify locations of the reflective markers; and tracking the HMD device according to the locations of the reflective markers.

In some embodiments, the markers are infrared light emitting diodes (IR LEDs), and the camera is an infrared (IR) camera; and the step of tracking the pose of the HMD device in the reference coordinate system by the camera of the mobile device includes: sensing, by the IR camera, IR light emitted by the IR LEDs; capturing, by the IR camera, a two-dimensional (2D) image of the IR LEDs based on the IR light; processing the 2D image by an image processing algorithm on the mobile device to identify locations of the IR LEDs; and tracking the HMD device according to the locations of the IR LEDs.

In some embodiments, the step of tracking the pose of the HMD device in the reference coordinate system by the camera of the mobile device includes: racking the pose of the HMD device in the reference coordinate system by the camera of the mobile device by a three-dimensional (3D) object pose estimation method.

In some embodiments, the step of tracking the pose of the mobile device in the reference coordinate system by the mobile device includes: tracking the pose of the mobile device in the reference coordinate system by a pose tracking module in the mobile device, the reference coordinate system is established by the pose tracking module.

In some embodiments, the HMD device is one of augmented reality (AR) glasses, mixed reality (MR) glasses, and virtual reality (VR) glasses, and the pose of the mobile device is a 6 degree-of-freedom (6 DoF) pose.

A head mounted display system and includes: a mobile device configured to track a pose of the mobile device in a reference coordinate system by the mobile device; and a head mounted display (HMD) device including at least one sensor and configured to track an image of the mobile device in the reference coordinate system via the at least one sensor and obtain localization information of the HMD device in the reference coordinate system based on the pose and the image of the mobile device.

In some embodiments, the mobile device includes a display, and the at least one sensor is an image sensor; and the image sensor is configured to track the image of the mobile device by capturing an image of at least one marker displayed by the display of the mobile device, and the HMD device is configured to process the image of the at least one marker captured by the HMD device and use the pose of the mobile device to obtain the localization information of the HMD device in the reference coordinate system.

In some embodiments, the at least one marker is a black/white image of a geometry primitive with a known size, or a natural color image with a certain number of distinctive features.

In some embodiments, the at least one sensor is a depth sensor, the depth sensor is configured to track the image of the mobile device by capturing a depth image of the mobile device and sensing depth data of the mobile device from the depth image, and the HMD device is configured to track the mobile device using the depth data and the pose of the mobile device.

In some embodiments, the mobile device is configured to track the pose of the mobile device in the reference coordinate system by a pose tracking module in the mobile device, the reference coordinate system is established by the pose tracking module.

In some embodiments, the HMD device is one of augmented reality (AR) glasses, mixed reality (MR) glasses, and virtual reality (VR) glasses, and the pose of the mobile device is a 6 degree-of-freedom (6 DoF) pose.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for tracking a head mounted display (HMD) device, comprising:
tracking a pose of a mobile device in a reference coordinate system by the mobile device;
tracking an image of the mobile device in the reference coordinate system by at least one sensor of the HMD device; and
obtaining, by the HMD device, localization information of the HMD device based on the pose and the image of the mobile device.

2. The method according to claim 1, wherein the mobile device comprises a display, and the at least one sensor is an image sensor;
wherein the step of tracking the pose of the mobile device in the reference coordinate system by the at least one sensor of the HMD device comprises:
tracking the image of the mobile device in the reference coordinate system by capturing, by the image sensor, an image of at least one marker displayed by the display of the mobile device; and
wherein the step of obtaining, by the HMD device, the localization information of the HMD device based on the pose and the image of the mobile device comprises:
obtaining, by the HMD device, the localization information of the HMD device by processing the image of the at least one marker captured by the HMD device and using the pose of the mobile device.

3. The method according to claim 2, wherein the at least one marker is a black/white image of a geometry primitive with a known size, or a natural color image with a certain number of distinctive features.

4. The method according to claim 1, wherein the at least one sensor is a depth sensor;
wherein the step of tracking an image of the mobile device in the reference coordinate system by the at least one sensor of the HMD device comprises:
tracking the image of the mobile device in the reference coordinate system by capturing, by the depth sensor, a depth image of the mobile device and sensing, by the depth sensor, depth data of the mobile device from the depth image; and
wherein the step of obtaining, by the HMD device, the localization information of the HMD device based on the pose and the image of the mobile device comprises:
obtaining, by the HMD device, the localization information of the HMD device based on the depth data and the pose.

5. The method according to claim 1, wherein the step of tracking an image of the mobile device in the reference coordinate system by the mobile device comprises:
tracking the pose of the mobile device in the reference coordinate system by a pose tracking module in the mobile device, wherein the reference coordinate system is established by the pose tracking module.

6. The method according to claim 1, wherein the HMD device is one of augmented reality (AR) glasses, mixed reality (MR) glasses, and virtual reality (VR) glasses, the pose of the mobile device is a 6 degree-of-freedom (6 DoF) pose, and the 6 DoF pose comprises 3 DoF positions and 3 DoF orientations of the mobile device.

7. The method according to claim 1, wherein the mobile device and the HMD device are tracked within a same reference coordinate system, wherein the reference coordinate system is established by a pose tracking module in the mobile device.

8. A method for tracking a head mounted display (HMD) device, comprising:
tracking a pose of a mobile device in a reference coordinate system by the mobile device; and
tracking a pose of the HMD device in the reference coordinate system by a camera of the mobile device.

9. The method according to claim 8, wherein the HMD device comprises a plurality of markers; and
wherein the step of tracking the pose of the HMD device in the reference coordinate system by the camera of the mobile device comprises:
tracking the pose of the HMD device in the reference coordinate system by observing the markers via the camera.

10. The method according to claim 9, wherein the markers are reflective markers, and the camera is an infrared (IR) emitting camera; and
wherein the step of tracking the pose of the HMD device in the reference coordinate system by the camera of the mobile device comprises:
emitting light by the IR emitting camera;
capturing, by the IR emitting camera, a two-dimensional (2D) image of the reflective markers based on light reflected by the reflective markers;
processing the 2D image by an image processing algorithm on the mobile device to identify locations of the reflective markers; and
tracking the HMD device according to the locations of the reflective markers.

11. The method according to claim 9, wherein the markers are infrared light emitting diodes (IR LEDs), and the camera is an infrared (IR) camera; and
wherein the step of tracking the pose of the HMD device in the reference coordinate system by the camera of the mobile device comprises:
sensing, by the IR camera, IR light emitted by the IR LEDs;
capturing, by the IR camera, a two-dimensional (2D) image of the IR LEDs based on the IR light;
processing the 2D image by an image processing algorithm on the mobile device to identify locations of the IR LEDs; and
tracking the HMD device according to the locations of the IR LEDs.

12. The method according to claim 8, wherein the step of tracking the pose of the HMD device in the reference coordinate system by the camera of the mobile device comprises:
tracking the pose of the HMD device in the reference coordinate system by the camera of the mobile device by a three-dimensional (3D) object pose estimation method.

13. The method according to claim 8, wherein the step of tracking the pose of the mobile device in the reference coordinate system by the mobile device comprises:
tracking the pose of the mobile device in the reference coordinate system by a pose tracking module in the mobile device, wherein the reference coordinate system is established by the pose tracking module.

14. The method according to claim 8, wherein the HMD device is one of augmented reality (AR) glasses, mixed reality (MR) glasses, and virtual reality (VR) glasses, and the pose of the mobile device is a 6 degree-of-freedom (6 DoF) pose.

15. A head mounted display system, comprising:
a mobile device configured to track a pose of the mobile device in a reference coordinate system by the mobile device; and
a head mounted display (HMD) device comprising at least one sensor and configured to track an image of the mobile device in the reference coordinate system via the at least one sensor and obtain localization information of the HMD device in the reference coordinate system based on the pose and the image of the mobile device.

16. The head mounted display system according to claim 15, wherein the mobile device comprises a display, and the at least one sensor is an image sensor; and
wherein the image sensor is configured to track the image of the mobile device by capturing an image of at least one marker displayed by the display of the mobile device, and the HMD device is configured to process the image of the at least one marker captured by the HMD device and use the pose of the mobile device to obtain the localization information of the HMD device in the reference coordinate system.

17. The head mounted display system according to claim 16, wherein the at least one marker is a black/white image of a geometry primitive with a known size, or a natural color image with a certain number of distinctive features.

18. The head mounted display system according to claim 15, wherein the at least one sensor is a depth sensor, the depth sensor is configured to track the image of the mobile device by capturing a depth image of the mobile device and sensing depth data of the mobile device from the depth image, and the HMD device is configured to track the mobile device using the depth data and the pose of the mobile device.

19. The head mounted display system according to claim 15, wherein the mobile device is configured to track the pose of the mobile device in the reference coordinate system by a pose tracking module in the mobile device, wherein the reference coordinate system is established by the pose tracking module.

20. The head mounted display system according to claim 15, wherein the HMD device is one of augmented reality (AR) glasses, mixed reality (MR) glasses, and virtual reality (VR) glasses, and the pose of the mobile device is a 6 degree-of-freedom (6 DoF) pose.
